(19) United States
(12) Patent Application Publication
(10) Pub. No.: US 2024/0239989 A1
(43) Pub. Date: Jul. 18, 2024

(54) STABILIZED POLYMER RESIN SYSTEMS HAVING HETEROPOLYOXOMETALATES FOR ANTIMICROBIAL PROPERTIES AND USES THEREOF

(71) Applicant: SPECIALTY OPERATIONS FRANCE, Lyon (FR)

(72) Inventors: Simon Guelen, Chabaniere (FR); Stephen John Walters, Worcestershire (GB); Eric Aubay, Sceaux (FR)

(73) Assignee: SPECIALTY OPERATIONS FRANCE, Lyon (FR)

(21) Appl. No.: 18/563,285

(22) PCT Filed: May 17, 2022
(86) PCT No.: PCT/EP2022/063309

§ 371 Date: Nov. 21, 2023

(30) Foreign Application Priority Data
May 21, 2021 (EP) 21175296.9

(51) Int. Cl. C08K 5/00; C08K 3/34

(52) U.S. Cl. CPC C08K 5/0091; C08K 3/346; C08K 5/005; C08K 5/0058

(57) ABSTRACT

Polymeric resin systems wherein organic polymers are stabilized with effective amounts of (i) heterpolyoxometalate compounds according to formulas (I), (II), and/or (III), (ii) a mineral carrier, and (iii) a free radical scavenger are provided herein. Such resin systems are characterized as possessing antimicrobial properties that prevent or reduce biofilm growth on a surface of a polymer substrate, which substrates include various polymeric articles, protective coatings, or sealants made from said resin systems.

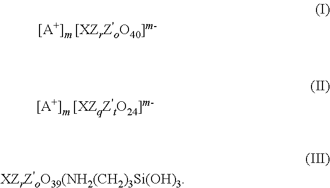

### BACKGROUND OF THE TECHNICAL FIELD AND RELATED ART

The technical field of the present disclosure generally relates to resin systems useful for making various polymeric articles or coatings. More specifically, the technical field of the present disclosure relates to stabilized resin systems having at least one organic polymer and a heteropolyoxometalate, which resin systems possess antimicrobial properties and are particularly useful for polymeric coating or sealants or for forming polymeric articles such as component parts for water-bearing devices, including household appliances.

Polymer resin systems (i.e., plastics) are widely used for abroad range of applications and component parts such as protective coatings, sealants, filtration membranes, air conditioning filters, trays such as table trays and storage trays that are used in home, commercial travel and public eating establishments, as well as shower trays in bathroom accessories, cooling tower packing and synthetic fabrics.

Various component parts formed from such polymers, frequently come into contact with dust, dirt, food or humidity, or may be touched by animals during use, which can give rise to growth of bacteria or mildew, or even provide a breeding ground for viruses. Problems concerning hygiene may thus arise from microorganisms that can attach to such plastic articles and proliferate. In particular, contaminated surfaces of substrates made from such resin systems can present a dirty, discolored appearance and foul smell. In a worst case, this may be even dangerous to an individual's health. In the case of cooling tower packing filter or membrane, such contamination can be detrimental to the functionality of the plastic, resulting in the fouling of the filter, membrane or cooling tower packing. Regular cleaning of such component parts (including those such as for household appliances) is thus recommended. However, in some cases the plastic component part is not easily accessible, e.g., if the component is part of a larger piece of equipment, such equipment may require to be turned off in order for the component part to be cleaned.

In some cases, a biofilm may be formed or has already formed on the surface of the component part. Biofilms, which consist of organic substances such as microorganisms and nutrients, lead to bad odor and/or visible contamination. This is in particular the case for articles or component parts which come into contact with food, dirty water, high humidity, or microorganisms (e.g., such as with vacuum cleaners).

In general, articles which have been soiled in various ways are cleaned in water-bearing household appliances. Food remains arise in dishwashers and the range of dirt occurring in laundry items to be cleaned in washing machines is typically even greater. Something that all water-bearing devices and/or household appliances have in common is that in the damp and warm atmosphere, in particular at less accessible sites, dirt can arise and accumulate. This dirt may be a good nutrient medium for organisms such as bacteria or fungi. Microorganisms tend to grow faster and easier in a damp atmosphere, in particular at less ventilated sites that are often also less accessible. For example, condensed water in a refrigerator or air conditioning filter may support the growth of microorganisms. Reservoirs for liquids such as water and milk, e.g. in coffee machines, are also prone to the growth of microorganisms.

Various measures for removing and/or preventing biofilms are known from the prior art. Cleaning with a biocide product is the most commonly used method but the requirement to stop operation of the device is not always possible if the plastic article or component part is not accessible. Disadvantageously, such cleaning also causes the release of biocide in the environment.

Some products such as silver, copper or zinc derivatives can be introduced into the resins and they are known to deliver biocide properties to the articles. However, such additives work by slowly releasing in the environment zinc, silver and copper and, consequently, can also have a negative impact on the environment. In addition, because of this mechanism of action, such additives are unable to deliver long lasting biocide properties. Finally, such additives do not really prevent the biofilm build-up because living bacteria can still grow on the surface of the dead bacteria on the surface of the plastic article.

U.S. Pat. No. 7,541,398 discloses methods for transforming conventional and commercially available polymers into durable and anti-microbial polymeric materials by blending such polymer resins with sterically hindered N-Halo-amines (N-halamines). The N-halamine additives are useful as antimicrobial agents.

Photocatalytic methods are also known in the prior art. For example, the use of catalytically effective compounds, and in particular titanium dioxide coatings for deodorizing, disinfecting and cleaning. Accordingly, the catalyst needs to be frequently activated by means of UV radiation. These compounds support the oxidative modification or destruction of microorganisms, such that (in the best case) they are totally removed by oxidation. However, this method often works insufficiently, and particularly if UV light is required in addition for the oxidation.

Further disadvantages of these known methods and measures are their high energy usage and the sometimes high apparatus and/or operating costs for achieving remarkable effects. In some methods, potentially health-endangering agents, for example ozone or UV radiation, are used so that additional safety measures are required.

The use of (hetero)polyoxometalates for plastic component parts as an antimicrobial active ingredient in the surface of such component parts is generally known.

The publications EP 2 761 073 B1 and US 2014/231363 A1 disclose a water-bearing domestic appliance having a container for receiving objects to be cleaned and at least one inner surface containing a catalytically active substance, said surface being disposed inside the domestic appliance, wherein the catalytically active substance is a polyoxometalate. The inner surface comes into contact with water to be cleaned during operation of the appliance. Typically, the polyoxometalate is tungstate. More typically, the tungstate is modified by titanium.

The publications DE 10 2013 205 302 A1 and WO 2014/154432 A1 disclose a household appliance that includes at least one catalytically effective substance in a surface, wherein the catalytically effective substance is a polyoxometalate that is included in an inner and/or outer surface of the household appliance, provided that the polyoxometalate is included in at least an outer surface of the household appliance, if the household appliance is a water-bearing household appliance having a container for receiving objects to be cleaned.

The publication WO 2014/122225 A1 discloses the use of a heteropolyoxometalate of the Formula (I), (II) or (III)

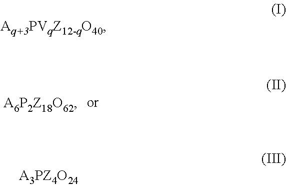

wherein
Z is selected from elements Mo or W,
index q=0, 1, 2 or 3, and
A is selected from one or more cations and comprises at least one cation selected from the group consisting of quaternary ammonium cations, quaternary phosphonium cations and tertiary sulfonium cations for providing self-cleaning, stripping, disinfecting, self-sanitizing, biocidal, antimicrobial, and/or deodorizing properties to at least part of a substrate or a surface of a substrate or to a coating or for decomposition and/or degradation of organic materials.

In Formula (I), Z is preferably Mo and q=2, and in Formula (III), Z is preferably W.

The publication EP 2 765 136 A1 discloses a heteropolyoxometalate of the Formula (I), (II) or (III)

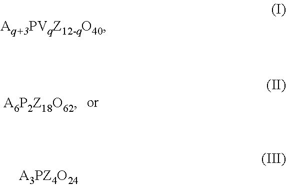

wherein
Z is selected from elements Mo or W,
q is 1, 2 or 3, and
A is selected from among one or more cations and comprises at least one quaternary ammonium cation with the proviso that the compounds [(n-C₄H₉)₄N]₃PMo₁₂O₄₀ and [(n-C₆H₉)₄N]₃PMo₁₂O₄₀ are exempted. Most preferred are the heteropolyoxometalates [(n-C₄H₉)₄N]₃PW₄O₂₄ and [(n-C₆H₁₃)₄N]₃PW₄O₂₄.

Publication EP 3175 867 discloses various formulations based on heteropolyoxometalate for coating on a surface of a substrate to impart anti-microbial properties. The substrate is selected from a polymer body, paint, varnish, ink, glass fibers, and inorganic oxide materials.

Publication EP 3 296 305 discloses a household appliance with an odor removal system that is part of a circuit in which a gas or aqueous liquid can be circulated through. The odor removal system contains heteropolyoxometalate which can be mixed with a polymeric binder such as acrylic/polyurethane and coated on the surface of a porous filter.

Publication WO 2018/050538 similarly discloses the use of heteropolyoxymetalates in a self-cleaning catalytically active surface coating used for a component of a household appliance. The component to be provided with a self-cleaning catalytically active surface is obtained by dip-coating the component into a liquid containing a polymeric organic or inorganic binder chosen from acrylate-based binders, polyurethane-based binders, and silicone-based binders, and a polyoxometalate to provide anti-microbial properties to the component surface.

However, the incorporation of polyoxometalates into polymers is difficult. If a coating approach is used (as in the references cited above), for example a component part containing a coating with polyoxometalates, most ofthe commercial coating systems react with the polyoxometalate, producing side reactions. This leads to a degradation of either the polyoxometalate or the coating system. Coatings in the case of such a polyoxometalate incorporation become fragile and can be easily removed from a polymeric support, i.e., a polymer substrate.

If a bulk approach is used, most of the polyoxometalates that are active as biocide agents degrade because of the harsh operating conditions that are needed for polymers to be processed. As an example, during the injection molding of polypropylene, the minimum temperature for the melting of polypropylene is 180° C. and the pressure is above atmospheric pressure. Experiments have shown that 80% of the polyoxometalate used degraded under these conditions. Moreover, the amount of polyoxometalate in the surface of a component part is often too low to allow an efficient antimicrobial use, since the percentage of the polyoxometalate that resists both methodologies, and that is available in the surface of the component part is often not sufficient.

The publication EP 3 459 423 B1 therefore discloses a household appliance with a component part containing a polymer and at least one polyoxometalate, wherein the polyoxometalate is anchored to a silica containing substrate.

Yet, it has been discovered in collaborative work done with the present inventors that when a polyoxometalate is incorporated into an organic polymer, a faster degradation of the organic polymer occurs. This finding is detrimental, and effectively teaches away from the use of such a polyoxometalate modified polymer material, which is especially true for its application in household appliances or other devices or equipment/tools that are water-bearing or are frequently exposed to liquids or high humidity.

Thus, several approaches have been made by the prior art to provide polymeric systems, and/or component parts made therefrom, having heteropolyoxometalate for the purpose of reducing and/or eliminating the deleterious effects of microorganism growth and spread across the surface of said polymeric articles or component parts. However, deficiencies associated with such polymeric systems or plastic component parts still remain.

Accordingly, there continues to be a need for an improved polymer resin system used to make various articles and component parts that are frequently exposed to conditions promoting the growth of microorganisms that give rise to biofilms, mold, and/or mildew. Preferably, a resin system that shows improvement in the chemical stability of both the heteropolyoxometalate and the organic polymer would be advantageous. In particular, such a resin system should also show less degradation during the manufacture of the polymeric component parts that contain heteropolyoxometalates. Therefore, polymer resin systems formed into such component parts, wherein the faster degradation of the organic polymer due to the presence of a heteropolyoxometalate can be reduced (yet the antimicrobial properties over a long time could be improved), would be highly advantageous and represent a useful advance in the art, and could find rapid acceptance in many industries, including, for example, that of devices or equipment that are water-bearing or frequently exposed to liquids or high humidity, e.g., household appliances.

### SUMMARY OF THE INVENTION

The foregoing and additional objects are achieved in accordance with the principles of the present invention, as recited by the corresponding independent and/or dependent claims, which embody the surprising discovery of certain polymer resin systems, whereby organic polymers containing heteropolyoxometalates, mineral carriers, and free radical scavengers possess antimicrobial properties and prevent or reduce biofilm growth on the surface of a substrate or component made from such polymer resin systems. Advantageously, and unexpectedly, such resin systems also show improvement in the chemical stability of the organic polymer such that polymeric articles and component parts made from such resin systems show less degradation over time. The results are surprising and unexpected because according to the expectations of those skilled in the art, the free radical scavenger should either inhibit the biocide benefit, or be inefficient to protect the plastic. Instead, it provides a positive synergistic effect.

Thus, in one aspect, the present invention provides a resin system having (a) an organic polymer and (b) a heteropolyoxometalate selected from the group consisting of:
a compound according to formula (I),

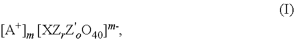

wherein
A⁺ is a quaternary phosphonium cation of formula (PR¹R²R³R⁴)⁺, wherein R¹ is a compound having from 8 to 20 carbon atoms and each of R², R³, and R⁴ is independently chosen from a compound having from 1 to 7 carbon atoms,
m− is the negative charge of the heteropolyoxometalate anion,
m is the number of the quaternary phosphonium cations required to compensate the negative charge m−,
Z and Z′ are independently chosen from elements W or Mo,
X is chosen from elements P or Si,
r and o are integers in the range of from 0 to 12, and
r+o=12;
a compound according to formula (II),

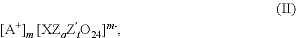

wherein
A⁺ is a quaternary phosphonium cation of formula (PR¹R²R³R⁴)⁺, wherein R¹ is a compound having from 8 to 20 carbon atoms and each of R², R³, and R⁴ is independently chosen from a compound having from 1 to 7 carbon atoms,
m− is the negative charge of the heteropolyoxometalate anion,
m is the number of the quaternary phosphonium cations required to compensate the negative charge m−,
Z and Z′ are independently chosen from elements W or Mo,
   X is chosen from elements P or Si,
   q and t are integers in the range of from 0 to 4, and
   q+t=4;
a compound according to formula (III),

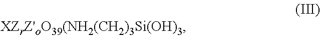

wherein
Z and Z′ are independently chosen from elements W or Mo,
X is chosen from elements P or Si,
r and o are integers in the range of from 0 to 12, and
r+o=12; and
mixtures of any of the foregoing heteropolyoxometalate compounds according to formula (I), (II), or (III);
(c) a mineral carrier; and
(d) a free radical scavenger,
   wherein the resin system is characterized as possessing antimicrobial properties that prevents or reduces biofilm growth on a surface material or component part formed from said resin system.

In another aspect, the invention provides methods for making stabilized polymer articles by, subjecting the resin system as described in detail herein to a molding process to form the article, and curing the polymer article to form a stabilized polymer article having antimicrobial and/or antibiofilm properties.

In still another aspect, the invention provides stabilized polymer articles made from the resin systems as described in detail herein. Such stabilized polymer articles include protective coatings and component parts for incorporating into various devices, equipment, machines, e.g., household appliances that are either water-bearing or that are exposed to liquids and/or high humidity for prolonged periods of time and are prone to growth of microorganisms and/or biofilms on their surface.

In yet a further aspect, the invention provides methods of using (i.e., use applications) such resin systems to form polymeric articles, which can be formed into a component part, protective coating, or mastic/sealant for use in a water-bearing appliance, device, or equipment.

These and other objects, features and advantages of this invention will become apparent from the following detailed description of the various aspects of the invention taken in conjunction with the accompanying Examples.

### DETAILED DESCRIPTION OF THE PREFERRED EMBODIMENTS

As employed throughout the present disclosure, certain terms are defined to assist the reader. Unless otherwise defined, all terms of art, notations and other scientific or industrial terms or terminology used herein are intended to have the meanings commonly understood by those of skill in the chemical, biochemical, and/or household appliance arts. In some cases, terms with commonly understood meanings are defined herein for clarity and/or for ready reference, and the inclusion of such definitions herein should not necessarily be construed to represent a substantial difference over the definition of the term as generally understood in the art unless otherwise indicated. As used herein and in the appended claims, the singular forms include plural referents unless the context clearly dictates otherwise.

As summarized above, it has now been discovered that when a heteropolyoxometalate is incorporated into an organic polymer with a free radical scavenger and a mineral carrier, the same antibiofilm performance and an improved polymer stability can be obtained. This is surprising because the free radical scavenger was expected to either inhibit the biocide benefit or be inefficient to protect the organic polymer to which it was added.

The present invention also has several advantages. The present invention provides resin systems for making stabilized polymer articles therefrom. Such resins can be incorporated into, for example, various coatings, devices, equipment, machines (e.g., household appliances), that are either water-bearing or that are exposed to liquids and/or high humidity for prolonged periods of time, and surprisingly maintain the combination of biocidal or antibiofilm properties, as well as a lack of oxidation of the polymer. The resin systems according to the present invention can be incorporated or made into said polymer articles such as component parts in an improved manner, because of the anti-microbial properties imparted by the polyoxometalate compounds. The stability of the polymer matrix is improved over polymer articles made into component parts that contain only an organic polymer and a heteropolyoxometalate.

Moreover, in any or all embodiments of the present invention, a lower concentration of polyoxometalate is required to obtain a plastic part having the same antimicrobial effectiveness. In addition, other negative side effects that occur upon the degradation of polyoxometalates such as, for example, unwanted colour changes, are avoided. Operational costs for the manufacturing process can also be reduced because lower concentrations of polyoxometalates are required for the manufacture of the resin system and ultimately the plastic part having the same biocide effect. This is particularly advantageous when the resin systems are formed into polymer articles such as component parts that are further incorporated into larger equipment or devices such as household appliances resulting in markedly lower susceptibility to dirt, grime, and foodstuffs and, thus, the eventual growth of microorganisms and/or biofilms. Thus, the oxygen radicals, which disinfect the interior of the various coatings, devices, equipment, machines (e.g., household appliances), that are either water-bearing or that are exposed to liquids and/or high humidity for prolonged periods of time, can be produced easily, at lower cost, and continuously.

In any or all embodiments of the invention, it is even possible to avoid any thermal or chemical degradation of the polyoxometalate compounds. Thus, the resin systems according to the present invention surprisingly, and simultaneously, show antimicrobial properties and a reduction in the growth of a biofilm on the surface of plastic articles made from such resin systems, as well as the avoidance of an oxidation of the polymer matrix when polyoxometalate compounds are tested as additives in polymer containing samples. Indeed, the phosphonium cations used in the present invention allow the polyoxometalate to be maintained in the resin system that is eventually formed into a component part and to prevent dissolution of the polyoxometalate into a surrounding liquid or gaseous medium or of any other depletion of it because of the contact with a surrounding medium.

Those skilled in the art will appreciate that, while preferred embodiments are discussed in more detail below, multiple embodiments of the resin systems, stabilized polymer articles incorporating such resin systems, applications and uses of such stabilized polymer articles (e.g., as protective coatings or as component parts for incorporation into various devices, equipment, or machines that are either water-bearing or that are exposed to liquids and/or high humidity for prolonged periods of time), and processes for manufacturing said resin systems and/or polymer articles, are contemplated as being within the scope of the present invention. Thus, it should be noted that any feature described with respect to one aspect or one embodiment of the invention is interchangeable with another aspect or embodiment of the invention unless otherwise stated.

Furthermore, for purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group consisting of any two or more of the explicitly listed elements, components, or features. Additionally, any element, component, or feature recited in such a list may also be omitted from such list.

Those skilled in the art will further understand that any recitation herein of a numerical range by endpoints includes all numbers subsumed within the recited range (including fractions), whether explicitly recited or not, as well as the endpoints of the range and equivalents. The term “et seq.” is sometimes used to denote the numbers subsumed within the recited range without explicitly reciting all the numbers. Disclosure of a narrower range or more specific group in addition to a broader range or larger group is not a disclaimer of the broader range or larger group.

### Resin Systems

The term “resin system” as used herein, refers to stabilized polymers as described herewith that are intended to be formed into various polymer articles or coatings for further incorporation into devices, equipment, machines (e.g., household appliances), that are either water-bearing or that are exposed to liquids and/or high humidity for prolonged periods of time. As will be appreciated by those skilled in the art, in certain contexts the resin systems can also include masterbatch compositions (i.e., a masterbatch resin system) wherein polymer (a) (a first polymer) contains the heteropolyoxometalates, mineral carrier, and free radical scavenger as described herein in elevated concentrations. Such masterbatch resin systems can then be blended with a second polymer material that is identical to, or compatible with, the first polymer material, to thereby form a stabilized polymer mixture which can be formed, shaped, or molded into a stabilized polymer article. Accordingly, the term “resin system” is to be understood broadly.

With reference to the resin systems as described herein, an “effective amount” means the quantity or concentration of component added to the polymer of the resin system on an active basis (such as the heteropolyoxometalates, mineral carrier, and free radical scavenger compounds described herein) necessary to provide the desired effect (e.g., stability or antimicrobial performance) to the polymer of the resin system or polymer articles made therefrom, when compared to an untreated polymer control system or resin system according to the prior art, as well as the polymeric articles made from such control or prior art resin systems.

In accordance with the above, the invention provides, in one aspect, a resin system including:
(a) an organic polymer (a first organic polymer);
(b) a heteropolyoxometalate selected from the group consisting of:
a compound according to formula (I),

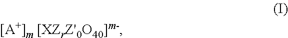

wherein
A⁺ is a quaternary phosphonium cation of formula (PR¹R²R³R⁴)⁺, wherein R¹ is a compound having from 8 to 20 carbon atoms and each of R², R³, and R⁴ is independently chosen from a compound having from 1 to 7 carbon atoms,
m− is the negative charge of the heteropolyoxometalate anion,
m is the number of the quaternary phosphonium cations required to compensate the negative charge m−,
Z and Z′ are independently chosen from elements W or Mo,
X is chosen from elements P or Si,
r and o are integers in the range of from 0 to 12, and
r+o=12;
a compound according to formula (II),

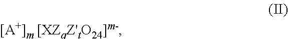

wherein
A⁺ is a quaternary phosphonium cation of formula (PR¹R²R³R⁴)⁺, wherein R¹ is a compound having from 8 to 20 carbon atoms and each of R², R³, and R⁴ is independently chosen from a compound having from 1 to 7 carbon atoms,
m− is the negative charge of the heteropolyoxometalate anion,
m is the number of the quaternary phosphonium cations required to compensate the negative charge m−,
Z and Z′ are independently chosen from elements W or Mo,
X is chosen from elements P or Si,
q and t are integers in the range of from 0 to 4, and
q+t=4;
a compound according to formula (III),

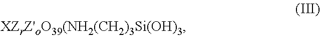

wherein
Z and Z′ are independently chosen from elements W or Mo,
X is chosen from elements P or Si,
r and o are integers in the range of from 0 to 12, and
r+o=12; and
mixtures of any of the foregoing heteropolyoxometalate compounds according to formula (I), (II), or (III);
(c) a mineral carrier; and
(d) a free radical scavenger,
   characterized in that the resin system possesses antimicrobial properties and prevents or reduces biofilm growth on a substrate surface.

In any or all embodiments of the resin system, a second organic polymer that is the identical to, or compatible with, the first organic polymer can be included.

In any or all embodiments, the first and/or second organic polymer is selected from the group consisting of polypropylene, polyethylene, polyethyleneterephthalate, other polyesters, polyamides, polyurethanes, polyacrylates, polycarbonate, polystyrene, polyimides, polyether sulfone, polyetherether ketone (PEEK), polyetherimide, polyethylene, polyphenylene oxide, polyphenylene sulfide (PPS), polyvinylfluoride, polyvinlydifluoride (PVDF), polymethacrylates, polyoxoalkylenes, poly(phenylene oxides), polyvinylesters, polyvinylethers, polyvinyl chloride (PVC), polyvinylidene chloride, acrylonitrile-butadiene-styrene, natural and synthetic polyisoprene, polybutadiene, chloroprene rubber, styrene-butadiene rubber, tetrafluoroethylene, silicone, acrylate resins, polyurethane resins, silicone resins, polyester resins, alkyd resins, epoxy resins, phenolic resins, and urea or amine based resins, or a mixture thereof

In certain preferred embodiments, the first and/or second organic polymer is selected from among polypropylene, polyethylene, polyamide 11, 12, 66, PEEK, PPS, PVDF, PVC, polyester, polycarbonate, polyurethane, ethylene propylene diene monomer (EPDM), polysulfone and polyether sulfone.

Ethylene propylene diene monomer (EPDM) is a copolymer of ethylene, propylene and a small amount of non-conjugated diene monomers (3-9 percent) which provide cross-linking sites for vulcanization:

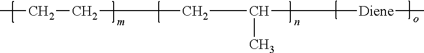

The diene is usually dicyclopentadiene, ethylidene nobomene, or 1,4 hexadiene. These terpolymers can be vulcanized by traditional techniques known to those skilled in the art.

In any or all embodiments of the resin system described herein, the mineral carrier (c) is preferably a silica, such as fumed silica or a precipitated silica, or an aluminosilicate such as a zeolite or a hallosyte. In certain preferred embodiments, the alumino silicate mineral is a hallosyte. A hallosyte is an alumino silicate mineral (aluminosilicate) with the formula Al₂Si₂O₅(OH)₄. The aluminosilicate and in particular hallosyte is demonstrated herein to be a very useful mineral carrier for the heteropolyoxometalate into the polymer matrix allowing better compatibility between the additive and the polymer matrix. It also protects the heteropolyoxometalate during extrusion and injection processes by retaining it in its pores and reducing the shear forces that may destroy the heteropolyoxometalate molecule when allowing it to move freely.

In any or all embodiments of the resin system according to the invention, the free radical scavenger can be a hindered amine light stabilizer (HALS), a hindered benzoate or a combination thereof. A hindered amine light stabilizer (HALS) is preferred in certain embodiments.

While any hindered amine light stabilizer is suitable for use in the resin systems described herein, particularly preferred hindered amines include, for example, at least one of bis(2,2,6,6-tetramethylpiperidin-4-yl) sebacate (TINUVIN™ 770); bis(2,2,6,6-tetramethylpiperidin-4-yl)succinate; bis(1,2,2,6,6-pentamethylpiperidin-4-yl)sebacate; bis(1-octyloxy-2,2,6,6-tetramethylpiperidin-4-yl)sebacate (TINUVIN™ 123); bis(1,2,2,6,6-pentamethylpiperidin-4-yl) n-butyl 3,5-di-tert-butyl-4-hydroxybenzylmalonate; a condensate of 1-(2-hydroxyethyl)-2,2,6,6-tetramethyl-4-hydroxypiperidine and succinic acid; 2,2,6,6-tetramethylpiperidin-4-yl stearate; 2,2,6,6-tetramethylpiperidin-4-yl dodecanate; 1,2,2,6,6-pentamethylpiperidin-4-yl stearate; 1,2,2,6,6-pentamethylpiperidin-4-yl dodecanate; a condensate of N,N′-bis(2,2,6,6-tetramethylpiperidin-4-yl)hexamethylenediamine and 4-tert-octylamino-2,6-dichloro-1,3,5-triazine; tris(2,2,6,6-tetramethylpiperidin-4-yl) nitrilotriacetate; 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; a condensate of N,N′-bis(2,2,6,6-tetramethylpiperidin-4-yl)hexamethylenediamine and 4-morpholino-2,6-dichloro-1,3,5-triazine; a condensate of N,N′-bis(2,2,6,6-tetramethylpiperidin-4-yl)hexamethylenediamine and 4-morpholino-2,6-dichloro-1,3,5-triazine, methylated; a condensate of 2-chloro-4,6-bis(4-n-butylamino-2,2,6,6-tetramethylpiperidyl)-1,3,5-triazine and 1,2-bis(3-aminopropylamino)ethane; a condensate of 2-chloro-4,6-bis(4-n-butylamino-1,2,2,6,6-pentamethylpiperidyl)-1,3,5-triazine and 1,2-bis-(3-aminopropylamino)ethane; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine, a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine; a condensate of 1,2-bis(3-aminopropylamino)ethane, 2,4,6-trichloro-1,3,5-triazine and 4-butylamino-2,2,6,6-tetramethylpiperidine; 2-undecyl-7,7,9,9-tetramethyl-1-oxa-3,8-diaza-4-oxospiro[4.5]decane; oxo-piperanzinyl-triazines; a reaction product of 7,7,9,9-tetramethyl-2-cycloundecyl-1-oxa-3,8-diaza-4-oxospiro[4.5]decane and epichlorohydrin; 1,2,3,4-butanetetracarboxylic acid, 2,2,6,6-tetramethyl-4-piperidinyl tridecyl ester; 1,2,3,4-butanetetracarboxylic acid, 1,2,2,6,6-pentamethyl-4-piperidinyl tridecyl ester; tetrakis(2,2,6,6-tetramethylpiperidin-4-yl)-1,2,3,4-butanetetracarboxylate; tetrakis(1,2,2,6,6-pentamethylpiperidin-4-yl)-1,2,3,4-butanetetracarboxylate; 1,2,3,4-butanetetracarboxylic acid, polymer with β,β,β′,β′-tetramethyl-2,4,8,10-tetraoxaspiro[5.5]-undecane-3,9-diethanol, 2,2,6,6-tetramethylpiperdin-4-yl ester; 1,2,3,4-butanetetracarboxylic acid, polymer with β,β,β′,β′-tetramethyl-2,4,8,10-tetraoxaspiro[5.5]-undecane-3,9-diethanol, 1,2,2,6,6-pentamethylpiperdin-4-yl ester; bis(1-undecanoxy-2,2,6,6-tetramethylpiperidin-4-yl)carbonate; 1-(2-hydroxy-2-methylpropoxy)-2,2,6,6-tetramethyl-4-piperdinol; 1-(2-hydroxy-2-methylpropoxy)-4-octadecanoyloxy-2,2,6,6-tetramethylpiperidine; 1-(4-octadecanoyloxy-2,2,6,6-tetramethylpiperidin-1-yloxy)-2-octadecanoyloxy-2-methylpropane; 1-(2-hydroxyethyl)-2,2,6,6-tetramethyl-4-piperdinol; a reaction product of 1-(2-hydroxyethyl)-2,2,6,6-tetramethyl-4-piperdinol and dimethyl succinate; 2,2,4,4-tetramethyl-7-oxa-3,20-diazadispiro[5.1.11.2]heneicosan-21-one; esters of2,2,6,6-tetramethyl-4-piperidinol with higher fatty acids; 3-dodecyl-1-(2,2,6,6-tetramethyl-4-piperidyl)pyrrolidine-2,5-dione; 1H-Pyrrole-2,5-dione, 1-octadecyl-, polymer with (1-methylethenyl)benzene and 1-(2,2,6,6-tetramethyl-4-piperidinyl)-1H-pyrrole-2,5-dione; 1,1′,1″-[1,3,5-triazine-2,4,6-triyl-tris[(cyclohexylimino)-2,1-ethanediyl]]tris[3,3,5,5-tetramethylpiperazin-2-one]; 1,1′,1″-[1,3,5-triazine-2,4,6-triyl-tris[(cyclohexylimino)-2,1-ethanediyl]]tris[3,3,4,5,5-pentamethylpiperazin-2-one]; the reaction product of 7,7,9,9-tetramethyl-2-cycloundecyl-1-oxa-3,8-diaza-4-oxospiro[4.5]decane and epichlorohydrin; the condensate of N,N′-bis(2,2,6,6-tetramethylpiperidin-4-yl)hexamethylenediamine and 4-cyclohexylamino-2,6-dichloro-1,3,5-triazine; the condensate of 1,2-bis(3-aminopropylamino)ethane, 2,4,6-trichloro-1,3,5-triazine and 4-butylamino-2,2,6,6-tetramethylpiperidine; the condensate of N,N′-bis(2,2,6,6-tetramethylpiperidin-4-yl)hexamethylenediamine and 4-morpholino-2,6-dichloro-1,3,5-triazine; the condensate of 2-chloro-4,6-bis(4-n-butylamino-2,2,6,6-tetramethylpiperidyl)-1,3,5-triazine and 1,2-bis(3-aminopropylamino)ethane; the condensate of 2-chloro-4,6-bis(4-n-butylamino-1,2,2,6,6-pentamethylpiperidyl)-1,3,5-triazine and 1,2-bis-(3-aminopropylamino)ethane; 2-[(2-hydroxyethyl)amino]-4,6-bis[N-(1-cyclohexyloxy-2,2,6,6-tetramethylpiperidin-4-yl)butylamino-1,3,5-triazine; propanedioic acid, [(4-methoxyphenyl)-methylene]-bis-(1,2,2,6,6-pentamethyl-4-piperidinyl) ester; benzenepropanoic acid, 3,5-bis(1,1-dimethylethyl)-4-hydroxy-, 1-[2-[3-[3,5-bis(1,1-dimethylethyl)-4-hydroxyphenyl]-1-oxopropoxy]ethyl]-2,2,6,6-tetramethyl-4-piperidinyl ester, N-(1-octyloxy-2,2,6,6-tetramethylpiperidin-4-yl)-N′-dodecyl-oxalamide; tris(2,2,6,6-tetramethylpiperidin-4-yl) nitrilotriacetate; 1,5-dioxaspiro{5,5}undecane-3,3-dicarboxylic acid, bis(1,2,2,6,6-pentamethyl-4-piperidinyl); 1,5-dioxaspiro{5,5}undecane-3,3-dicarboxylic acid, bis(2,2,6,6-tetramethyl-4-piperidinyl); the condensate of 1-(2-hydroxyethyl)-2,2,6,6-tetramethyl-4-hydroxypiperidine and succinic acid; the condensate of N,N′-bis(2,2,6,6-tetramethylpiperidin-4-yl)hexamethylenediamine and 4-tert-octylamino-2,6-dichloro-1,3,5-triazine; a mixture of 2,2,4,4-tetramethyl-21-oxo-7-oxa-3.20-diazaspiro(5.1.11.2)-heneicosane-20-propanoic acid-dodecyl ester and 2,2,4,4-tetramethyl-21-oxo-7-oxa-3.20-diazaspiro(5.1.11.2)-heneicosane-20-propanoic acid-tetradecyl ester; 1H,4H,5H,8H-2,3a,4a,6,7a,8a-hexaazacyclopenta[def]fluorene-4,8-dione, hexahydro-2,6-bis(2,2,6,6-tetramethyl-4-piperidinyl); polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; copolymer of methyl methacrylate with ethyl acrylate and 2,2,6,6-tetramethylpiperidin-4-yl acrylate; copolymer of mixed C₂₀ to C₂₄ alpha-olefins and (2,2,6,6-tetramethylpiperidin-4-yl)succinimide; 1,3-benzenedicarboxamide, N,N′-bis(2,2,6,6-tetramethyl-4-piperidinyl); 1,1′-1,10-dioxo-1,10-decanediyl)-bis(hexahydro-2,2,4,4,6-pentamethylpyrimidine; ethane diamide, N-(1-acetyl-2,2,6,6-tetramethylpiperidinyl)-N′-dodecyl; formamide, N,N′-1,6-hexanediylbis[N-(2,2,6,6-tetramethyl-4-piperidinyl) (UVINUL™ 4050); d-glucitol, 1,3:2,4-bis-O-(2,2,6,6-tetramethyl-4-piperidinylidene)-; 2,2,4,4-tetramethyl-7-oxa-3,20-diaza-21-oxo-dispiro[5.1.11.2]heneicosane; propanamide, 2-methyl-N-(2,2,6,6-tetramethyl-4-piperidinyl)-2-[(2,2,6,6-tetramethyl-4-piperidinyl)amino]-; 7-oxa-3,20-diazadispiro[5.1.11.2]heneicosane-20-propanoic acid, 2,2,4,4-tetramethyl-21-oxo-, dodecyl ester; N-(2,2,6,6-tetramethylpiperidin-4-yl)-β-aminopropionic acid dodecyl ester; N-(2,2,6,6-tetramethylpiperidin-4-yl)-N′-aminooxalamide; N-(2,2,6,6-tetramethyl-4-piperidinyl)-3-[(2,2,6,6-tetramethyl-4-piperidinyl)amino]-propanamide; 3-dodecyl-1-(1,2,2,6,6-pentamethylpiperidin-4-yl)pyrrolidine-2,5-dione, 3-dodecyl-1-(1-ethanoyl-2,2,6,6-pentamethylpiperidin-4-yl)pyrrolidine-2,5-dione; bis(2,2,6,6-tetramethylpiperidin-4-yl)succinate; bis(1,2,2,6,6-pentamethylpiperidin-4-yl) n-butyl 3,5-di-tert-butyl-4-hydroxybenzylmalonate; tris(2,2,6,6-tetramethylpiperidin-4-yl) nitrilotriacetate; 1,1′-(1,2-ethanediyl)bis(3,3,5,5-tetramethylpiperazin-2-one); 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; 2-undecyl-7,7,9,9-tetramethyl-1-oxa-3,8-diaza-4-oxospiro[4.5]decane; 1,5-dioxaspiro{5,5}undecane-3,3-dicarboxylic acid, bis(2,2,6,6-tetramethyl-4-piperidinyl) ester; 1,5-dioxaspiro{5,5}undecane-3,3-dicarboxylic acid, bis(1,2,2,6,6-pentamethyl-4-piperidinyl) ester; N¹-(D-hydroxyethyl)-3,3-pentamethylene-5,5-dimethylpiperazin-2-one; N¹-tert-octyl-3,3,5,5-tetramethyl-diazepin-2-one; N¹-tert-octyl-3,3-pentamethylene-5,5-hexamethylene-diazepin-2-one; N¹-tert-octyl-3,3-pentamethylene-5,5-dimethyl-piperazin-2-one; trans-1,2-cyclohexane-bis-(N¹-5,5-dimethyl-3,3-pentamethylene-piperazin-2-one); trans-1,2-cyclohexane-bis(N¹-3,3,5,5-dispiropentamethylene-piperazin-2-one); N¹-isopropyl-1,4-diazadispiro-3,3,5,5-pentamethylenepiperazin-2-one; N¹-isopropyl-1,4-diazadispiro-3,3-pentamethylene-5,5-tetramethylene-piperazin-2-one; N¹-isopropyl-5,5-dimethyl-3,3-pentamethylene-piperazin-2-one; trans-1,2-cyclohexane-bis-N′-(dimethyl-3,3-pentamethylene-piperazin-2-one); N¹-octyl-5,5-dimethyl-3,3-pentamethylene-1,4-diazepin-2-one; N¹-octyl-1,4-diazadispiro-(3,3,5,5)pentamethylene-1,5-diazepin-2-one; a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371); N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200); TINUVIN™ XT-850/XT-855; N-butyl-2,2,6,6-tetramethyl-4-piperidinamine-2,4,6-trichloro-1,3,5-triazine (FLAMESTAB™ NOR 116).

In any or all embodiments, the hindered amine light stabilizer (HALS), can be at least one of:
bis(2,2,6,6-tetramethylpiperidin-4-yl) sebacate (TINUVIN™ 770);
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidyl) succinate;
bis(1-octyloxy-2,2,6,6-tetramethylpiperidin-4-yl) sebacate (TINUVIN™ 123);
bis(1,2,2,6,6-pentamethylpiperidin-4-yl) n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanate;
1,2,2,6,6-pentamethylpiperidin-4-yl stearate;
1,2,2,6,6-pentamethylpiperidin-4-yl dodecanate;
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
tris(2,2,6,6-tetramethylpiperidin-4-yl) nitrilotriacetate;
4-stearyloxy-2,2,6,6-tetramethylpiperidine;
a condensate of N,N′-bis(2,2,6,6-tetramethylpiperidin-4-yl)hexamethylenediamine and 4-morpholino-2,6-dichloro-1,3,5-triazine (CYASORB™ UV-3346);
a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
a condensate of 2-chloro-4,6-bis(4-n-butylamino-1,2,2,6,6-pentamethylpiperidyl)-1,3,5-triazine and 1,2-bis-(3-aminopropylamino)ethane;
a condensate of N,N′-bis(2,2,6,6-tetramethylpiperidin-4-yl)hexamethylenediamine, N-butyl-2,2,6,6-tetramethyl-4-piperidinamine, di-n-butyl amine, and 2,4,6-trichloro-1,3,5-triazine (CHIMASSORB™ 2020);
a mixture of 4-hexadecyloxy- and 4-stearyloxy-2,2,6,6-tetramethylpiperidine (CYASORB™ UV-3853);
a mixture of 4-hexadecyloxy- and 4-stearyloxy-1,2,2,6,6-pentamethylpiperidine;
a condensate of N,N′-bis(2,2,6,6-tetramethylpiperidin-4-yl)hexamethylenediamine and 4-cyclohexylamino-2,6-dichloro-1,3,5-triazine;
a condensate of 1,2-bis(3-aminopropylamino)ethane, 2,4,6-trichloro-1,3,5-triazine, and 4-butylamino-2,2,6,6-tetramethylpiperidine;
a condensate of N,N′-bis(2,2,6,6-tetramethylpiperidin-4-yl)hexamethylenediamine and 4-cyclohexylamino-2,6-dichloro-1,3,5-triazine;
tetrakis(2,2,6,6-tetramethylpiperidin-4-yl)-1,2,3,4-butanetetracarboxylate;
tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidinyl-4-yl tridecyl ester;
1,2,3,4-butanetetracarboxylic acid, 1,2,2,6,6-pentamethylpiperidin-4-yl tridecyl ester;
formamide, N,N′-1,6-hexanediylbis[N-(2,2,6,6-tetramethylpiperidin-4-yl) (UVINUL™ 4050);
a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371;
N,N′-bis(2,2,6,6-tetramethyl-4-piperidin-4-yl)hexamethylene diamine, polymer with 2,4,6-trichloro-1,3,5-triazine, reaction products with 3-bromo-1-propene,
di-n-butylamine, and N-butyl-2,2,6,6-tetramethyl-4-piperidinamine, oxidized, hydrogenated (TINUVIN™ XT 200);
TINUVIN™ XT-850/XT-855); or
N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

In certain embodiments, the hindered amine light stabilizer (HALS) can include at least one of a sterically hindered N-halo-amine as described in U.S. Pat. No. 7,541,398.

When present, the sterically hindered N-halo-amine is preferably selected from one or more of the following:
bis(N-halo-2,2,6,6-tetramethyl-4-piperidyl)sebacate;
poly[[6-[(1,1,3,3-tetramethylbutyl)amino]-s-triazine-2,4-diyl]-N-halo-[(2,2,6,6-tetramethyl-4-piperidyl)imino]-hexamethylene-[(2,2,6,6-tetramethyl-4-piperidylimino]];
N-halo-[(2,2,6,6-tetramethyl-4-piperidyl)alkyl formate];
poly[(6-morpholino-s-triazine-2,4-diyl)-N-halo-[2,2,6,6-tetramethyl-4-piperidyl]imino]-hexamethylene[(2,2,6,6-tetramethyl-4-piperidyl)imino]];
3-dodecyl-N-halo-(2,2,6,6-tetramethyl-4-piperidinyl)succinimide;
2,2,4,4-tetramethyl-N-halo-7-oxa-3,20-diazadispiro[5.1.11.2]-heneicosan-21-one;
D-glucitol, 1,3:2,4-bis-O-(N-halo-2,2,6,6-tetramethyl-4-piperidinylidene);
1,1′-ethylenebis (N-halo-3,3,5,5-tetramethyl-piperazinone);
N-halo-2,2,4,4-tetramethyl-7-oxa-20-(oxiranylmethyl)-3,20-diazadispiro[5.1.11.2]henicosan-21-one;
1,2,3,4-butanetetracarboxylic acid, polymer with β,β,β′,β′-tetramethyl-2,4,8,10-tetraoxaspiro[5.5]unde-cane-3,9-diethanol, N-halo-2,2,6,6-tetramethyl-4-piperidinyl ester;
poly[oxy[methyl[3-[N-halo-(2,2,6,6-tetramethyl4-piperidinyl)-oxy]propyl]silylene]];
1,1′,1″-[1,3,5-triazine-2,4-6-triyltris[(cyclohexylimino)ethylene]]tris(N-halo-3,3,5,5-tetramethyl-piperazinone); and mixtures and combinations thereof, wherein halo is Cl or Br or I.

In other embodiments, such sterically hindered N-halo-amines are excluded from the resin systems according to the invention.

In any or all embodiments, the hindered benzoate can be, for example, at least one of 2,4-di-tert-butylphenyl-3,5-di-tert-butyl-4-hydroxybenzoate, hexadecyl-3,5-di-tert-butyl-4-hydroxybenzoate (CYASORB™ UV-2908), octadecyl-3,5-di-tert-butyl-4-hydroxybenzoate, octyl-3,5-di-tert-butyl-4-hydroxybenzoate, decyl-3,5-di-tert-butyl-4-hydroxybenzoate, dodecyl-3,5-di-tert-butyl-4-hydroxybenzoate, tetradecyl-3,5-di-tert-butyl-4-hydroxybenzoate, behenylyl-3,5-di-tert-butyl-4-hydroxybenzoate, 2-methyl-4,6-di-tert-butylphenyl-3,5-di-tert-butyl-4-hydroxybenzoate, or butyl-3-[3-tert-butyl-4-(3,5-di-tert-butyl-4-hydroxybenzoyloxy)phenyl]propionate.

In any or all embodiments according to the resin system of the present invention, the heteropolyoxometalate is chosen from a subformula of formula (I), (II), or (III), which includes subformula (I′), (II′) and/or (III′), as described below:

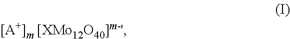

wherein
A⁺ is a quaternary phosphonium cation,
m− is the negative charge of the heteropolyoxometalate anion,
m is the number of the quaternary phosphonium cations required to compensate the negative charge m−,
X is chosen from elements P or Si;

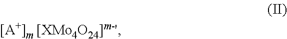

wherein
A⁺ is a quaternary phosphonium cation,
m− is the negative charge of the heteropolyoxometalate anion,
m is the number of the quaternary phosphonium cations required to compensate the negative charge m−,
X is chosen from elements P or Si;

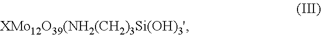

wherein
X is chosen from elements P or Si;
wherein the cation A⁺ is a quaternary phosphonium cation with the formula (PR¹R²R³R⁴)⁺,
   wherein R¹ is a compound having from 8 to 20 carbon atoms and each of R², R³, and R⁴ is independently chosen from a compound having from 1 to 7 carbon atoms.

In certain preferred embodiments, X is element Si. In any or all embodiments, the polyoxometalate suitable for use in the resin systems of the invention is selected from among [(CH₃(CH₂)₁₃P⁺(CH₂CH₂CH₂CH₃)]₄[SiMo₁₂O₄₀] (an example of a Keggin form), [(CH₃(CH₂)₁₃P⁺(CH₂CH₂CH₂CH₃)]4[SiMo₄O₂₄] (an example of a Venturillo form) and [(CH₃(CH₂)₁₃P⁺(CH₂CH₂CH₂CH₃)]4[SiMo₁₂O₃₉ (H₂N(CH₂)₃Si(OH)₃)] (an example of an anchorable form), and mixtures thereof.

Generally, polyoxometalates based on the elements molybdenum (Mo) or tungsten (W) are known in the art, in particular as Keggin-type heteropolyoxometalate anions [XZi₂O₄₀]ⁿ⁻ wherein the central heteroatom (X) can be e.g. phosphorus (P⁵⁺), silicon (Si⁴⁺), germanium (Ge⁴⁺), aluminum (Al³⁺), boron (B³⁺) etc. Further, in the Keggin-type polyoxometalate based on molybdenum or tungsten a number (1 or more) of molybdenum or tungsten atoms can be replaced by titanium atoms (e.g. Ti⁴⁺), vanadium atoms (e.g. V⁵⁺), nickel atoms (e.g. Ni²⁺), iron atoms (e.g. Fe³⁺), cobalt atoms (e.g. Co²⁺ or Co³⁺), zinc atoms (Zn²⁺), chromium atoms (e.g. Cr²⁺ or Cr³⁺), manganese atoms (e.g. Mn²⁺) etc. Another example of polyoxometalate anions is the Venturello structure [XZ₄O₂₄].

In any or all embodiments of the resin systems described herein, the heteropolyoxometalate compounds have molybdenum or tungsten oxide subunits which, optionally, can be replaced in parts by titanium, vanadium, manganese, iron, cobalt, nickel or chromium oxide subunits.

The heteropolyoxometalates of formulae (I), (II), and (III), and sub-formulae thereof, as described herein can be prepared according to processes known by those skilled in the art.

In any or all embodiments of the resin systems herein described, the phosphonium cations A⁺ are selected such that the charge of the heteropolyoxometalate compound of Formula (I), (II), and (III), as well as subformulas (I′) and (II′), is zero.

In the same or other embodiments of the resin system, optionally at least two of the residues R¹, R², R and R⁴ in the phosphonium cation A⁺ are part of a ring, or form a ring together with the phosphor atom. Each of R¹, R², R and R⁴ may be chosen from branched or straight, saturated or unsaturated, substituted or unsubstituted alkyl groups, aryl groups or heteroaryl groups. The terms “alkyl,” “aryl,” and “heteroaryl” are terms of art and are used herein in their ordinary sense. A comprehensive list of abbreviations utilized by chemists (i.e., persons representing the level of those of ordinary skill in the art) appears in the first issue of each volume of the Journal of Organic Chemistry. The list, which is typically presented in a table entitled “Standard List of Abbreviations,” can serve as a reference to the meanings of these terms in this regard.

These phosphonium cations have antimicrobial properties contributing to the antimicrobial properties of the overall heteropolyoxometalate species, and to its ability to reduce the biofilm growth on the surface of a polymer article substrate incorporated in various devices, equipment, machines (e.g., household appliances), that are either water-bearing or that are exposed to liquids and/or high humidity for prolonged periods of time and, thus, prone to growth of microorganisms.

The presence of a quaternary phosphonium cation also renders the heteropolyoxometalates as described herein less soluble or even insoluble in water. Preferably, the solubility of the heteropolyoxometalates used for the resin systems according to the present invention is below 10 mg/ml in water, preferably below 5 mg/ml in water, more preferably below 1 mg/ml in water, still more preferably below 0.5 mg/ml in water, even more preferably below 0.1 mg/ml water, and most preferably below 0.01 mg/ml water, wherein said water has a temperature of 20° C. Stated another way, the solubility of the heteropolyoxometalates suitable for use in the resin systems according to the present invention ranges from below 10 mg/ml in water to below 0.01 mg/ml in water at 20° C.

The lower solubility, or even insolubility for aqueous liquids, also contributes to the long term efficacy of the heteropolyoxometalate compounds regarding the reduction of the biofilm growth on the polymer substrate surface, and the long term efficacy of the antimicrobial activity, since the heteropolyoxometalates suitable for use with the resin systems according to the invention are not washed out of the polymer article over time upon frequent or prolonged exposure to water or moisture.

In any or all embodiment of the resin system, R¹ of the heteropolyoxometalate may be chosen from, for example, octyl, nonyl, decyl, undecyl, dodecyl, tridecyl, tetradecyl, pentadecyl, hexadecyl, heptadecyl, octadecyl, nonadecyl, or eicosanyl alkyl residues. In certain embodiments of the resin system R¹ of the heteropolyoxometalate is preferably straight.

In any or all embodiments of the resin system according to the invention, each of R², R³ and R⁴ can independently be chosen from methyl, ethyl, propyl, butyl, pentyl, hexyl, or heptyl alkyl residues.

In certain embodiments, resin systems having phosphonium cations, wherein at least one of the groups R¹, R², R³, or R⁴ is chosen from a substituted or nonsubstituted alkyl, alkyloxoalkyl or cycloalkyl group that optionally includes at least one heteroatom chosen from O, S, N or P, are preferred.

The term “substituted”, whether preceded by the term “optionally” or not, is a broad term that is used herein in its ordinary sense as understood by those skilled in the art. “Substituted” thus includes replacement of one or more hydrogen radicals in a given structure with one or more substituent groups, which may be any permissible organic substituents of the given structure. Examples of substituents that may be permissible for a given structure include hydroxy; C₁₋₁₀ alkyl; C₁₋₁₀ alkenyl; allyl; halogen; C₁₋₁₀ haloalkyl; C₁₋₁₀ alkoxy; hydroxy C₁₋₁₀ alkyl; carboxy; C₁₋₁₀ carboalkoxy (also referred to as alkoxycarbonyl); C₁₋₁₀ carboxyalkoxy; C₁₋₁₀ carboxamido (also referred to as alkylaminocarbonyl); cyano; formyl; C₁₋₁₀ acyl; nitro; amino; C₁₋₁₀ alkylamino; C₁₋₁₀ dialkylamino; anilino; mercapto; C₁₋₁₀ alkylthio; sulfoxide; sulfone; C₁₋₁₀ acylamino; amidino; phenyl; benzyl; heteroaryl; heterocycle; phenoxy; benzoyl; benzoyl substituted with amino, hydroxy, methoxy, methyl or halo; benzyloxy and heteroaryloxy. When the substituted group contains an alkyl segment, two hydrogen atoms on the same carbon atom may be replaced by a single substituent double bonded to the carbon atom (e.g., oxo (═O)).

In the same or other embodiments of the resin system according to the present invention, quaternary phosphonium cations are chosen from one or more of methyltrioctylphosphonium, tributyltetradecylphosphonium, tributyldodecylphosphonium, trihexyltetradecylphosphonium, trihexylhexadecylphosphonium, tributyloctylphosphonium, tributylnonylphosphonium, tributyldecylphosphonium, tributylundecylphosphonium, tributyldodecylphosphonium, tributyltridecylphosphonium, tributyltetradecylphosphonium, tributylpentadecyl-phosphonium, tributylhexadecylphosphonium, trihexyloctylphosphonium, trihexylnonylphosphonium, trihexyldecylphosphonium, trihexylundecyl-phosphonium, trihexyldodecylphosphonium, trihexyltridecylphosphonium, trihexyltetradecylphosphonium, trihexylpentadecylphosphonium or trihexylhexadecylphosphonium.

In certain embodiments, the use of the phosphonium cations described herein will be more advantageous as compared to, for example, ammonium cations, depending on the temperatures used in the extrusion of the polymer. For example, the extrusion or injection moulding of polypropylene is conducted at temperatures >180° C., but ammonium cations degrade in general at >140° C.

In certain embodiments of the resin system according to the present invention, a heteropolyoxometalate compound having a phosphonium cation is preferred, wherein R¹of the phosphonium cation includes at least 8, more preferably at least 10, and most preferably at least 13 carbon atoms.

In the same or other embodiments, each of R², R³, and R⁴ of the cation is independently chosen from 1 to 4 carbon atoms.

In any or all embodiments of the resin systems according to the invention, the heteropolyoxometalate compound can include tetradecyltributylphosphonium cation, which has been found to be advantageous with respect to its biocidal performance.

In any and all embodiments, the resin systems described herein can include further optional additives that can include at least one compound chosen from co-additives; nucleating agents; fillers; reinforcing agents; and combinations thereof.

Examples of such additives include, but are not limited to:
basic co-additives, for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids for example calcium stearate, zinc stearate, magnesium behenate, magnesium stearate, sodium ricinoleate and potassium palmitate, antimony pyrocatecholate or zinc pyrocatecholate;
nucleating agents, for example, inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers);
fillers and reinforcing agents, for example, calcium carbonate, silicates, glass fibres, glass bulbs, asbestos, talc, kaolin, mica, barium sulfate, metal oxides and hydroxides (e.g., aluminium hydroxide or magnesium hydroxide, carbon black, graphite, wood flour and flours or fibers of other natural products, synthetic fibers; impact modifiers;
benzofuranones and indolinones, for example those disclosed in U.S. Pat. Nos. 4,325,863; 4,338,244; 5,175,312; 5,216,052; 5,252,643; 5,369,159; 5,488,117; 5,356,966; 5,367,008; 5,428,162; 5,428,177; 5,516,920; DE-A-4316611; DE-A-4316622; DE-A-4316876; EP-A-0589839 or EP-A-0591102 or 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-dimethylphenyl)-5,7-di-tert-butyl-benzofuran-2-one;
metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl) hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide;
nitrones, for example, N-benzyl-alpha-phenyl-nitrone, N-ethyl-alpha-methyl-nitrone, N-octyl-alpha-heptyl-nitrone, N-lauryl-alpha-undecyl-nitrone, N-tetradecyl-alpha-tridcyl-nitrone, N-hexadecyl-alpha-pentadecyl-nitrone, N-octadecyl-alpha-heptadecyl-nitrone, N-hexadecyl-alpha-heptadecyl-nitrone, N-ocatadecyl-alpha-pentadecyl-nitrone, N-heptadecyl-alpha-heptadecyl-nitrone, N-octadecyl-alpha-hexadecyl-nitrone, nitrone derived from N,N-di(hydrogenated tallow)hydroxylamine;
thiosynergists, for example, dilauryl thiodipropionate or distearyl thiodipropionate; and
peroxide scavengers, for example esters of D3-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(O-dodecylmercapto)propionate.

Other additives suitable for use with the present invention that would not markedly impair the properties of the polymeric material to be stabilized are known to those of ordinary skill in the art and can include, for example, plasticisers, lubricants, emulsifiers, pigments, rheology additives, catalysts, flow-control agents, optical brighteners, flameproofing agents, antistatic agents, clarifying agents and blowing agents.

Those of ordinary skill in the art will be able to readily determine the amount and type of additive(s) that should be added based on preparations as known and/or described in the literature, or through no more than routine experimentation.

Polymer Articles Formed from said Resin Systems

The resin systems described herein are useful for preparing stabilized polymer articles and/or protective coatings. It was surprisingly found that such polymeric articles, which can include, for example, component parts for devices, equipment, machines (e.g., household appliances) that are either water-bearing or that are exposed to liquids and/or high humidity for prolonged periods of time, retain their biocidal properties after 24h of contact with detergents, by virtue of being made from the resin systems described herein, which contain one of the aforementioned polyoxometalates and mineral carriers. Without the content of the mineral carrier (and preferably the aluminosilicate), the polymeric article loses these biocidal properties.

In certain embodiments, the polymer article formed from the resin systems according to the invention contains a second organic polymer that can be the same as, or compatible with, the polymer component (a) of the resin system (i.e., a first organic polymer). In certain preferred embodiments where the polymeric articles are made into component parts for incorporating into household appliances, the polymer article includes a thermoplastic, an elastomer, a thermoplastic elastomer, a duroplast, or a mixture thereof.

The term “thermoplastic”, as used herein, refers to a polymer that becomes pliable or moldable above a specific temperature and solidifies upon cooling. Examples for thermoplastic polymers include but are not limited to polyacrylates, acrylonitrile-butadiene-styrenes, polyamides such as nylon, polyacetic acid, polybenzimidazole, polycarbonate, polyether sulfone, polyetherether ketone (PEEK), polyetherimide, polyethylene, polyphenylene oxide, polyphenylene sulfide (PPS), polypropylene, polystyrene, polyvinylchloride (PVC), polyethyleneterephthalate, polyvinylfluoride, polyvinyldifluoride, polyurethane, polyester and polytetrafluoroethylene (e.g. Teflon).

Accordingly, preferred polymer articles, made from the resin systems described herein, for incorporation in various equipment or devices such as household appliances, for example, can also contain an organic polymer that is selected from the group consisting of polypropylene and an ethylene propylene diene monomer (EPDM) polymer.

The term “elastomer”, as used herein, refers to a polymer with viscoelasticity (having both viscosity and elasticity). Examples for elastomers include but are not limited to unsaturated rubbers such as natural polyisoprene (natural rubber), synthetic polyisoprene, polybutadiene, chloroprene rubber, butyl rubber, styrene-butadiene rubber, (hydrogenated) nitrile rubber, saturated rubbers such as ethylene propylene rubber, ethylene propylene diene rubber, epichlorohydrin rubber, polyacrylic rubber, silicone, silicone rubber, fluorosilicone rubber, fluoro- and perfluoroelastomers, and ethylene-vinyl acetate.

The term “thermoplastic elastomer”, as used herein, refers to a class of copolymers or a physical mix of polymers which consists of materials with both thermoplastic and elastomeric properties. Examples for thermoplastic elastomers include but are not limited to styrenic block copolymers, polyolefin blends, elastomeric alloys, thermoplastic polyurethanes, thermoplastic copolyesters, and thermoplastic polyamides.

The term “duroplast”, as used herein, refers to a polymer which is no longer pliable after curing. Examples for duroplasts include but are not limited to aminoplasts, phenoplasts, epoxy resins, polyacrylates, polyurethanes, polyesters, urea formaldehyde resins, melamine formaldehyde resins, and phenol formaldehyde resins.

In any or all embodiments of the stabilized polymer articles, the organic polymer is selected from the group consisting of polypropylene, polyethylene, polyethyleneterephthalate, other polyesters, polyamides, polyurethanes, polyacrylates, polycarbonate, polystyrene, polyimides, polyether sulfone, polyetherether ketone (PEEK), polyetherimide, polyethylene, polyphenylene oxide, polyphenylene sulfide (PPS), polyvinylfluoride, polyvinlydifluoride (PVDF), polymethacrylates, polyoxoalkylenes, poly(phenylene oxides), polyvinylesters, polyvinylethers, polyvinyl chloride (PVC), polyvinylidene chloride, acrylonitrile-butadiene-styrene, natural and synthetic polyisoprene, polybutadiene, chloroprene rubber, styrene-butadiene rubber, tetrafluoroethylene, silicone, acrylate resins, polyurethane resins, silicone resins, polyester resins, alkyd resins, epoxy resins, phenolic resins, and urea or amine based resins, or a mixture thereof.

Accordingly, in another aspect the present invention provides polymeric articles made from such resin systems as described herein. In any or all embodiments of such polymeric articles, the article preferably includes, based on the total contents of the constituents (a), (b), (c) and (d),
34 wt.-% to 92.95 wt.-% at least one organic polymer (a);
2 wt.-% to 30 wt.-% heteropolyoxometalate (b);
5 wt.-% to 35 wt.-% mineral carrier (c); and
0.05 wt.-% to 1 wt.-% free radical scavenger (d).

In certain preferred embodiments, the polymer article includes, based on the total contents of the constituents (a), (b), (c) and (d),
54.5 wt.-% to 79.9 wt.-% of at least one organic polymer (a);
5 wt.-% to 15 wt.-% heteropolyoxometalate (b);
15 wt.-% to 30 wt.-% mineral carrier (c); and
0.1 wt.-% to 0.5 wt.-% free radical scavenger (d).

In any or all embodiments of the polymer article, the polyoxometalate is contained at least in a surface layer that has a thickness of from 0.01 to 0.5 mm. In certain preferred embodiments, the surface layer has a polyoxometalate content in the range of from 1 to 50 wt. %, (e.g., 1, 2, 3, 4, 5, et seq., 10, 15, 20, 25, 30, 35, 40, 45, 50 wt. %, including any whole or partial value in between) based on the weight of the surface layer of the polymer article (i.e., substrate).

### Methods of Manufacturing

In another aspect, the invention provides processes for the manufacture of a polymer article having antimicrobial and/or antibiofilm properties, by:
(i) subjecting a resin system as described herein to a molding process to form a molded polymer article; and
(ii) curing the molded polymer article;
   thereby forming a stabilized polymer article having antimicrobial and/or antibiofilm properties.

In certain embodiments of the process for the manufacture of the stabilized polymer article, the organic polymer is polypropylene and the steps (i) and (ii) are performed at a temperature of between 190 to 210° C. for 1 to 10 minutes. Again, the polymer selected to form the manufactured article can be the same or different than the polymer of the resin system, so long as the polymers are compatible.

Depending on the final application or intended use of the stabilized polymeric article, the molding processes contemplated for use in the methods for manufacturing the stabilized polymer article include any of compounding processes, pressureless processing techniques (e.g. casting, dipping, coating, foaming), compression molding, rolling and calendaring, extrusion, blow molding, rotomolding, or injection molding processes, or drawing, thermoforming or printing. Such processes are well known to those skilled in the art.

A further aspect of the methods of manufacture includes methods for preparing the resin systems described herein. According to such methods, effective amounts of the various components of the resin system are admixed together and then extruded through any suitable device to form the stabilized resin system according to the invention. Alternatively, the resin mixture can be pelletized by any means known to those skilled in the art.

Although the components of the resin system can be generally admixed in any order using equipment and according to processes known to those skilled in the art, in certain embodiments the heteropolyoxometalate component (b) is first admixed with the mineral carrier (c). Then, that combination is admixed with at least one organic polymer (a) provided in a molten or viscous state, and a free radical scavenger (d). The admixture is then extruded or pelletized according to known processes to provide the resin system according to the invention.

### Applications & Uses

The surfaces of the polymer article substrates made from the stabilized resin systems according to the invention are shown to have desirable characteristics useful for imparting antimicrobial properties to said surfaces, due to incorporation of the heteropolyoxometalate compounds in the resin systems described herein. The heteropolyoxometalates simultaneously reduce growth of biofilms on the substrate surface, and the polymer article can be molded into any suitable plastic component for incorporation into any device or equipment prone to biofilm growth.

The heteropolyoxometalate compounds included in the stabilized resin systems according to the invention generally include a cationic moiety A⁺, which imparts antimicrobial activity to the compound, and an anion. The heteropolyoxometalates show a flexible redox behavior, which means that they can be reversibly reduced by one or more electrons. In particular, and without wishing to be bound by theory, it is believed that the heteropolyoxometalate compounds have the ability to activate molecular oxygen and/or hydrogen peroxide such that an electron is transferred from the heteropolyoxometalate compound to molecular oxygen and/or hydrogen peroxide, thereby resulting in the formation of reactive oxygen species (ROS) such as the hyperoxide anion (O₂⁻), and an oxidized heteropolyoxometalate species. Preferably, the molecular oxygen is activated over hydrogen peroxide.

The reactive oxygen species formed by heteropolyoxometalate-induced activation of molecular oxygen and/or hydrogen peroxide reduces the growth of a biofilm on a surface of a substrate provided in the form of a polymeric article made from the resin systems comprising the heteropolyoxometalate. This, in turn, is useful for maintaining the antimicrobial activity of the polymeric article such as a component part incorporated into devices, equipment, machines (e.g., household appliances), that are either water-bearing or that are exposed to liquids and/or high humidity for prolonged periods of time and are, therefore, prone to growth of microorganisms and/or biofilms.

Accordingly, the stabilized polymer resin systems described herein are useful for making, for example, protective coatings (such as a coating for floor, roof, marine coating for ships, sealants, mastics or adhesives, e.g., that are used in bathrooms or kitchens that join pieces of ceramics or vinyl), filtration membranes (such as ultrafiltration membranes and microfiltration membranes for waste water discharge filtration), air filters (such as filters used in air conditioning filters), trays (such as table trays and storage trays that are used in home, commercial travel and public eating establishments, as well as shower trays in bathroom accessories), cooling tower packings, and synthetic fabrics.

It is further believed, that the cationic moiety A⁺ of the oxidized heteropolyoxometalate species then reacts with the negatively charged cell membrane of a microorganism thereby killing the microorganism, resulting in an antimicrobial activity of the heteropolyoxometalate and of the polymer article formed with resin systems described herein that include the heteropolyoxometalate.

The heteropolyoxometalates used in the resin systems of the present invention thus provide a synergistic effect. When said resin systems are used to form polymeric article substrates, which can include, for example, component parts for household appliances or other devices, the heteropolyoxometalates impart antimicrobial properties to the surface substrate because of their ability to react with the cell membranes of microorganisms growing thereon. The heteropolyoxometalates also have the ability to generate reactive oxygen species (ROS), particularly the hyperoxide anion (O₂⁻), that reduces the growth of a biofilm on the surface of the substrate, which incorporates the heteropolyoxometalate and provides prolonged periods of antimicrobial activity to the substrate.

As used herein, the term “microorganism” includes bacteria, viruses, fungi, molds and algae. The microorganism is preferably bacteria.

The term “biofilm”, as used herein, refers to an assembly of microorganisms wherein cells stick to each other on the surface of a substrate such as a polymer article. Such polymer articles can include component parts of various devices, equipment, machines (e.g., household appliances), that are either water-bearing or that are exposed to liquids and/or high humidity for prolonged periods of time. The term “growth of biofilm” or “biofilm growth”, as used herein, refers to the microorganism build-up adhering to a surface substrate of a same or similar polymer article or component part.

The term “home appliance” is interchangeably used with “household appliance” and refers to any device, equipment and/or machinery (including communication and data processing devices suitable and intended to interact with the appliances for private household applications), which incorporate one or more plastic parts formed from a resin system as described herein. In particular, the household appliances include, but are not limited to, stoves, ovens, baking ovens, microwaves, cooker hoods, dishwashers, laundry machines, dryers, refrigerators, freezers, vacuum cleaners, coffee machines, water boilers, deep fryers, irons, hair dryers, shavers, kitchen machines and kitchen devices, barbeque devices, steam cookers, electrical small instantaneous water heaters, devices for heating and storing water for the kitchen and the bathroom, as well as robotic applications insofar they are intended for private household applications.

In certain embodiments, the device, equipment or machinery incorporating a plastic component made from a resin system according to the invention is preferably a water-bearing household appliance. In general, a “water-bearing household appliance” is a household appliance that uses water during operation. The items to be cleaned can be, in particular, tableware or laundry items. As used or referred to herein, the term “cleaning” should also be understood to mean “freshening”. Accordingly, the present invention is also intended to be useful for making component parts for household appliances that do not specifically use water, such as a dryer, or other such appliance or device, for example, but which may be exposed to conditions of high humidity or dampness for prolonged periods.

Preferably, the water-bearing household appliance is a dishwasher or a laundry treatment device or a coffee making machine. More preferably the laundry treatment device/appliance is selected from the group consisting of a washing machine, a washer-dryer combo, and a dryer.

In another preferred embodiment, the polymer article is in the form of a water filtration membranes and prevents the fouling of the filtration membranes.

In another preferred embodiment, the polymer article is in the form of a protective coating and prevents growth of microorganisms at the coated surface. In the case of marine coatings, such a coating prevents the fouling of the exterior of the ship, which is very detrimental to the ship's energy consumption.

In another preferred embodiment, the polymer article is in the form of an air conditioning filter and prevents bacteria growth that can include bad smell. Additionally, the air filtration becomes more efficient as the filter can remove from the air virus, bacteria and volatile organic compounds.

In another preferred embodiment, the polymer article is in the form of a sealant (e.g., silicone sealant), mastic or adhesive.

### Examples and Comparative Examples

The following examples are provided to assist one skilled in the art to further understand certain embodiments of the present invention. These examples are intended for illustration purposes and are not to be construed as limiting the scope of the various embodiments of the present invention, as defined by the claims.

Manufacture of polymer-containing sheets as examples for component parts of a household appliance:

The polymer sheets of the EXAMPLES ACCORDING TO THE INVENTION and the COMPARATIVE EXAMPLES are produced by extrusion of polypropylene (PP) at a temperature of 200° C. with a residence time of 4 min and at 90 rotations per minute (rpm).

### Examples According to the Invention

In the extruder, the PP is mixed with a mixture of one of the following polyoxometalates and halloyste as carrier, as well as with the antioxidant CYASORB UV-3529 (available from SOLVAY S. A., Brussels, Belgium).

The composition of each sheet is as follows:
70 wt.-% polypropylene
10 wt.-% heteropolyoxometalate
19.8 wt.-% hallosyte
0.2 wt.-% CYASORB® UV-3529

CYASORB® UV-3529 is based on hindered amine light stabilizer (HALS) chemistry, and has the following chemical composition:
1,6-Hexanediamine, N,N′-bis(2,2,6,6-tetramethyl-4-piperidinyl)-, polymers with morpholine-2,4,6-trichloro-1,3,5-triazine reaction products methylated.

The following three heteropolyoxometalates are used in the EXAMPLES:

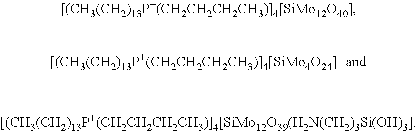

The polymer sheets of the EXAMPLES ACCORDING TO THE INVENTION are evaluated regarding their biocidal effect, i.e. E. Coli biofilm reduction, by comparison with a reference with virgin polypropylene as COMPARATIVE EXAMPLE. In this regard the following classification is used.
Biofilm Level 1: Single bacteria (attached bacteria without aggregates) (best)
Biofilm Level 2: Cell-cell adhesion (first aggregates or mono-layer)
Biofilm Level 3: Bacteria clustering (multiple aggregates or multi-layers)
Biofilm Level 4: Young biofilm (clusters with live/dead bacteria)
Biofilm Level 5: Mature biofilm (very high density of live/dead bacteria clusters) (worst)

The three sheets according to the present invention all show Biofilm Level 1 behavior (best) while the sheet of the COMPARATIVE EXAMPLE with polypropylene as such shows Biofilm Level 5 behavior (worst). Results are obtained using an optical microscope and specific fluorescence labels to the biofilm. The methodology is created by combining two independent protocols:
(a) ASTM E2196-12; and
(b) Publication: “Quantification of biofilm in microtiter plates: overview of testing conditions and practical recommendations for assessment of biofilm production by staphylococci,” STEPANOVIĆ, Srdjan, et al.

The antibiofilm properties are evaluated according to an internal protocol based on the ASTM E2196-12 standard (Standard Test—“Method for Quantification of Pseudomonas aeruginosa Biofilm Grown with Medium Shear and Continuous Flow Using Rotating Disk Reactor”). The main steps are as follows:
Preparation of an inoculum of E. Coli ATCC 8736 in peptone water (106 UFC/ml);
Cleaning of the samples with ethanol and distilled water;
Contamination of the samples by immersion in the inoculum solution;
Incubation of the samples for 48 h at 37° C.;
Removal of the samples and raise with PBS buffer;
Application of the LIVE/DEAD® solution to dye bacteria on the surface of the sample; and
Prospecting the samples under an epifluorescence microscope to check the biofilm level (from 1 to 5, see above).

To confirm the results, 3 replicates of each sample are analyzed on different days. It was surprisingly found that a polymeric sheet, e.g., a component part of a household appliance that contains one of the aforementioned heteropolyoxometalates and hallosyte, retains its biocidal properties after 24 h of contact with detergents. Without the hallosyte content, the polymeric sheet lost these biocidal properties.

Moreover, the following aging tests are conducted in the EXAMPLES ACCORDING TO THE INVENTION based on standards for polypropylene AT-EN IS 6270-2. The tests are successfully passed by the samples according to the present invention; the results are shown in the following Table.

TABLE 1

| Tests | Time | | Requirements to be fulfilled |
|---|---|---|---|
| UV resistance | 250 | h | No visible cracks when magnified |
| | | | 500 times with a microscope |
| Alternating | 21 | cycles | No visible cracks when magnified |
| Climate AF* | | | 500 times with a microscope |
| Heating at 70° C. | 3 | weeks | No visible cracks when magnified |
| | | | 500 times with a microscope |
| Brittle test | 200 | h | No embrittling |
| Heating at 95° C. | 5 weeks | | No visible cracks when magnified |
| | (850 hours) | | 500 times with a microscope |
| Steam at 95° C. | 5 weeks | | No visible cracks when magnified |
| | (850 hours) | | 500 times with a microscope |
| Steam at 70° C. | 6 | weeks | No visible cracks when magnified |
| | | | 500 times with a microscope |

*Specific test designed to test the thermal fatigue resistance of a material. Test conditions are 16 h at 40° C. alternating with 8 h at 25° C. (one cycle) for an uninterrupted 21 days.

Various patent and/or scientific literature references have been referred to throughout this application. However, if a term in the present application contradicts or conflicts with a term in those references, the term from the present application takes precedence over the conflicting term from the cited reference. In view of the above description and the examples, one of ordinary skill in the art will be able to practice the invention as claimed, and without undue experimentation.

While typical embodiments have been set forth for the purpose of illustrating the fundamental novel features of the present invention, the foregoing descriptions should not be deemed to be a limitation on the scope herein. Accordingly, various modifications, adaptations, and alternatives can occur to one skilled in the art without departing from the spirit and scope of the invention described herein, and the scope of the invention should be defined by the appended claims, as read in view of the context of the detailed description and its teachings as a whole. The terms “comprised of,” “comprising,” or “comprises” as used in the description and/or claims include embodiments “consisting essentially of” or “consisting of” the listed elements and the terms “including” or “having” in context of describing the invention should be equated with “comprising”.

1. A resin system comprising:
(a) a first organic polymer;
(b) a heteropolyoxometalate selected from the group consisting of:
a compound according to formula (I), 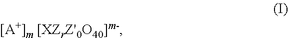
wherein
A⁺ is a quaternary phosphonium cation of formula (PR¹R²R³R⁴)⁺, wherein R¹ is a compound having from 8 to 20 carbon atoms and each of R², R³, and R⁴ is independently chosen from a compound having from 1 to 7 carbon atoms,
m− is the negative charge of the heteropolyoxometalate anion,
m is the number of the quaternary phosphonium cations required to compensate the negative charge m−,
Z and Z′ are independently chosen from elements W or Mo,
X is chosen from elements P or Si,
r and o are integers in a range from 0 to 12, and r+o=12;
a compound according to formula (II), 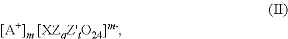
wherein
A⁺ is a quaternary phosphonium cation of formula (PR¹R²R³R⁴)⁺, wherein R¹ is a compound having from 8 to 20 carbon atoms and each of R², R³, and R⁴ is independently chosen from a compound having from 1 to 7 carbon atoms,
m− is the negative charge of the heteropolyoxometalate anion,
m is the number of the quaternary phosphonium cations required to compensate the negative charge m−,
Z and Z′ are independently chosen from elements W or Mo,
X is chosen from elements P or Si,
q and t are integers in a range from 0 to 4, and q+t=4;
a compound according to formula (III), 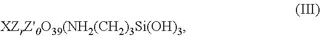
wherein
Z and Z′ are independently chosen from elements W or Mo,
X is chosen from elements P or Si,
r and o are integers in a range from 0 to 12, and r+o=12; and
mixtures of any of the foregoing heteropolyoxometalate compounds according to formula (I), (II), or (III);
(c) a mineral carrier; and
(d) a free radical scavenger,
characterized in that the resin system possesses antimicrobial properties and prevents or reduces biofilm growth on a surface of a polymer substrate formed from said resin system.

2. The resin system according to claim 1, wherein the resin system comprises a second organic polymer that is identical to, or compatible with, the first polymer.

3. The resin system according to claim 1, wherein the mineral carrier (c) is an alumino silicate mineral chosen from a zeolite or a hallosyte or a silica mineral.

4. The resin system according to claim 1, wherein R¹ is a substituent that includes at least 10 carbon atoms.

5. The resin system according to claim 1, wherein each of R², R³, and R⁴ is independently chosen from a substituent having from 1 to 4 carbon atoms.

6. The resin system according to claim 1, wherein the free radical scavenger is a hindered amine light stabilizer (HALS), a hindered benzoate, or a combination thereof.

7. The resin system according to claim 1, wherein the heteropolyoxometalate is selected from the group consisting of:
a compound according to formula (I′): 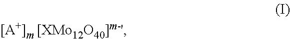
wherein the values for A⁺, m, m−, and X are as defined in claim 1;
a compound according to formula (II′): 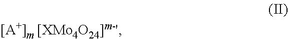
wherein the values for A⁺, m, m−, and X are as defined in claim 1;
a compound according to formula (III′) 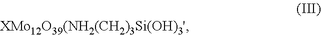
wherein the values for A⁺, m, m−, and X are as defined in claim 1; and
mixtures of any of the compounds according to formula (I′), (II′), or (III′).

8. The resin system according to claim 1, wherein at least one of the substituents R¹, R², R³, and R⁴ is a substituted or nonsubstituted alkyl group, substituted or nonsubstituted alkyloxoalkyl group or substituted or nonsubstituted cycloalkyl group, wherein at least one carbon atom of any of said alkyl group, alkyloxoalkyl group, or cycloalkyl group is optionally replaced by at least one heteroatom selected among O, S, N and P.

9. The resin system according to claim 1, wherein the heteropolyoxometalate is selected from the group consisting of
[(CH₃(CH₂)₁₃P⁺(CH₂CH₂CH₂CH₃)]₄[SiMo₁₂O₄₀],
[(CH₃(CH₂)₁₃P⁺(CH₂CH₂CH₂CH₃)]₄[SiMo₄O₂₄],
[(CH₃(CH₂)₁₃P⁺(CH₂CH₂CH₂CH₃)]₄[SiMo₁₂O₃₉(H₂N(CH₂)₃Si(OH)₃)], and mixtures thereof.

10. The resin system according to claim 1, wherein the first and/or a second polymer is a member selected from the group consisting of thermoplastic polymers, viscoelastic polymers, thermoplastic elastomers, and duroplasts.

11. A polymer article prepared from a resin system according to claim 1, wherein the article includes, based on the total contents of the constituents (a), (b), (c) and (d),
34 wt.-% to 92.95 wt.-% of organic polymer (a);
2 wt.-% to 30 wt.-% heteropolyoxometalate (b);
5 wt.-% to 35 wt.-% mineral carrier (c); and
0.05 wt.-% to 1 wt.-% free radical scavenger (d); or
wherein the article includes, based on the total contents of the constituents (a), (b), (c) and (d),
54.5 wt.-% to 79.9 wt.-% of the organic polymer (a);
5 wt.-% to 15 wt.-% heteropolyoxometalate (b);
15 wt.-% to 30 wt.-% mineral carrier (c); and
0.1 wt.-% to 0.5 wt.-% free radical scavenger (d).

12. A method for preparing a stabilized polymer article having antimicrobial and/or antibiofilm properties, the method comprising:
(i) subjecting a resin system as defined by claim 1 to a molding process to form a molded polymer article; and
(ii) curing the molded polymer article, thereby forming a stabilized polymer article having antimicrobial and/or antibiofilm properties.

13. The method according to claim 12, wherein the first organic polymer (a) is polypropylene and the molding process is performed at a temperature of between 190 to 210° C. for 1 to 10 minutes.

14. A method of forming a stabilized polymer article comprising forming a stabilized polymer article with a resin system according to claim 1.

15. The method according to claim 14, wherein the stabilized polymer article forms a protective coating or a sealant or a component part for use in a water-bearing appliance or device, wherein the water-bearing appliance or device is selected from the group consisting of a cooling tower; water filtration membranes; water pipes; medical devices; air filters; and food trays.

16. The resin system according to claim 1, wherein the mineral carrier (c) is a hallosyte.

17. The resin system according to claim 1, wherein R¹ is a substituent that includes at least at least 13 carbon atoms.

18. The resin system according to claim 1, wherein the first and/or the second polymer is a member selected from the group consisting of polypropylene, polyethylene, polyethyleneterephthalate, other polyesters, polyamides, polyurethanes, polyacrylates, polycarbonate, polystyrene, polyimides, polymethacrylates, polyoxoalkylenes, poly(phenylene oxides), polyvinylesters, polyvinylethers, polyvinylidene chloride, acrylonitrile-butadiene-styrene, natural and synthetic polyisoprene, polybutadiene, chloroprene rubber, styrene-butadiene rubber, tetrafluoroethylene, silicone, acrylate resins, polyurethane resins, silicone resins, polyester resins, alkyd resins, epoxy resins, phenolic resins, and urea or amine based resins, and mixtures thereof.

19. The resin system according to claim 1, wherein the first and/or the second polymer is chosen from polypropylene or a copolymer comprising ethylene propylene diene monomer (EPDM).
